(19) United States
(12) Patent Application Publication
(10) Pub. No.: US 2011/0181107 A1
(43) Pub. Date: Jul. 28, 2011

(54) SWITCHING ASSEMBLY FOR THE TOP PORTION OF AN AUTOMOBILE STEERING COLUMN, AND CORRESPONDING CONTROL ASSEMBLY AND METHOD

(75) Inventor: Michel Hallet, Mondeville (FR)

(73) Assignee: SC2N, Creteil (FR)

(21) Appl. No.: 13/002,341

(22) PCT Filed: Jul. 3, 2009
(86) PCT No.: PCT/EP09/58460

§ 371 Date: Mar. 17, 2011

(30) Foreign Application Priority Data
Jul. 3, 2008 (FR) 0803762

(51) Int. Cl. B60L 1/00

(52) U.S. Cl. 307/9.1

(57) ABSTRACT

The invention relates to a switching assembly for the top portion of an automobile steering column that comprises: a base substrate (5) having a plurality of locations (E1, E2, E3, E4) connectable to switching module (7) connectors, each switching module (7) having at least one switch (15) capable of going into switching mode on the basis of the control position used by a user; a microcontroller (17) for managing the switching assembly, characterized in that: each location (E1, E2, E3, E4) includes at least two digital inputs connected to identical digital outputs (s1, s2) of said microcontroller (17) and at least two digital outputs connected to identical digital inputs (e1, e2, e3, e4) of said microcontroller (17); and said microcontroller (17) is configured to be able to deduce, from a sequence of digital signals sent by said microcontroller (17) to each location and digital signals received by said microcontroller (17) from each location (E1, E2, E3, E4) and corresponding to electric signals having transited through a switching module connected to a location, at least one switching mode of a switch of said switching module. The invention also relates to a corresponding control assembly and control method.

The present invention relates to a switching assembly for the top of a steering column of a motor vehicle, and corresponding control assembly and method.

Widely known in the prior art are control assemblies for a top of a steering column of a motor vehicle.

Such assemblies combine in one and the same system several switching modules for, for example, controlling headlights, windshield wipers, audio functions, telephony functions or else speed regulators, connected to a switching assembly beneath the steering wheel.

A switching assembly usually comprises a basic support having a plurality of locations that can be connected to switching module connectors, each switching module having at least one switch that can adopt a switching state depending on the control position applied by a user.

For the management of the controls, document WO2007/028887 proposes a switching assembly comprising a microcontroller configured to periodically activate at each location the reading of the switching states of the modules.

The object of the present invention is to propose a switching system that is simplified and more efficient than that of the prior art at a reduced cost.

Accordingly, the subject of the invention is a switching assembly for the top of a steering column of a motor vehicle comprising:
a basic support having a plurality of locations that can be connected to switching module connectors, each switching module having at least one switch that can adopt a switching state depending on the control position applied by a user,
a microcontroller for managing the switching assembly,
   characterized in that each location comprises at least two digital inputs connected to identical digital outputs of said microcontroller and at least two digital outputs connected to identical digital inputs of said microcontroller and in that said microcontroller is configured so as to be able to deduce from a sequence of digital signals sent by said microcontroller to each location and digital signals received by said microcontroller from each location and corresponding to electric signals having passed through a switching module plugged into a location, at least one switching state of a switch of said switching module.

The coding possibilities are then very high. The switching system is therefore simplified, more efficient and is less costly.

Each location may have the same predefined number of lands. Therefore, the electrical connection system is standardized and is identical for all the switching modules that may be connected to the basic support. It is therefore possible to connect switching modules assigned to different functions to different locations of the basic support.

The microcontroller may be configured to receive an item of digital information also comprising an identifier associated with the location of said module. Since the switching modules may have an identical connection system, the identifier associated with the location of the switching module then makes it possible to recognize the functions to which the module is dedicated.

A further subject of the invention is a control assembly for the top of a steering column of a motor vehicle, characterized in that it comprises a switching assembly as described above, and at least one switching module plugged into a location of the switching assembly, said module having at least one switch that can adopt a switching state according to a control position applied by a user.

According to one embodiment, a predefined number of switches of a switching module are connected on the one hand respectively to an identical number of outputs of said microcontroller and, on the other hand, to a single input of said microcontroller. For example, in order to determine the switching states of some twenty switches, it is sufficient to wire four switches on the one hand to four outputs of a microcontroller and on the other hand to a single input of the microcontroller. Four outputs and five inputs are therefore sufficient instead of twenty inputs and twenty outputs. This considerably reduces the number of outputs of the microcontroller and the wiring necessary to determine the switching states of the switches.

According to various features of the control assembly,
the switch of the switching module comprises contacting elements and a corresponding switching member, the position of the switching member defining a combination of contacts supplying an item of digital information at the input of said microcontroller relative to a switching state,
the contacting elements are inscribed in an arc of a circle band of a support of said module and said switching member is mounted rotatably on said support,
the contacting elements are duplicated for each position of the switching member with the exception of a central position; the duplicating of the contacting elements makes it possible to protect the routing of the electric signals in transit,
the contacting elements are placed so that the switching states are closed in a central position of the switching member in order to carry out an operating test of said module.

A further subject of the invention is a control method for the top of a steering column of a motor vehicle, characterized in that it comprises a control assembly as described above for the application of the following steps:
a first step in which, in turn and periodically for each location, a sequence of digital signals is sent via said microcontroller,
a second step in which, from each location, corresponding digital signals are received via said microcontroller, which signals being associated with electric signals that have passed through a switching module plugged into said location and, from said sequences of digital signals sent and from said corresponding digital signals received, at least one switching state of a switch of said switching module is deduced,
a third step in which the switching states are associated with a series of corresponding control signals and the corresponding control signals are delivered to the elements that are to be controlled and,
said steps are reiterated.

During the second step, it is possible also to deduce from said sequences of digital signals sent and from said corresponding digital signals received, at least one identifier associated with the location of said module.

During the second step, it is possible to store the switching state of a second preceding step, the switching state is compared with the stored switching state, and if there is a change of switching state, the second step is reiterated until the switching state is at least identical to that stored. This ensures that the user has indeed desired a change of state before the latter is made effective.

Other advantages and features will appear on reading the description of the invention and the appended drawings in which:

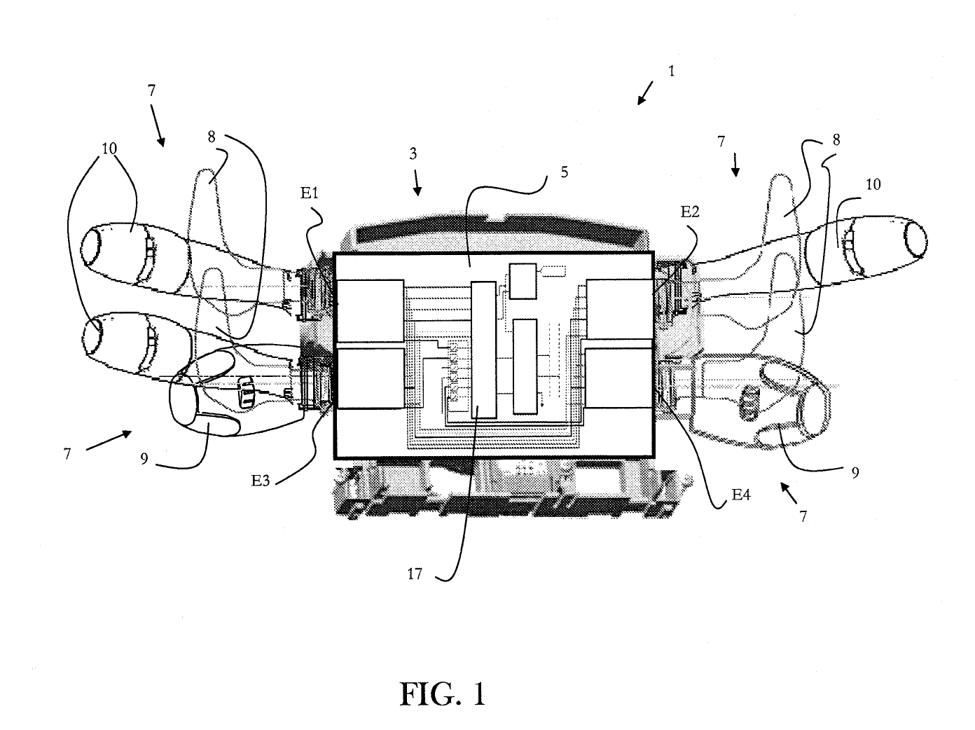

FIG. 1 is a schematic view of a control assembly,

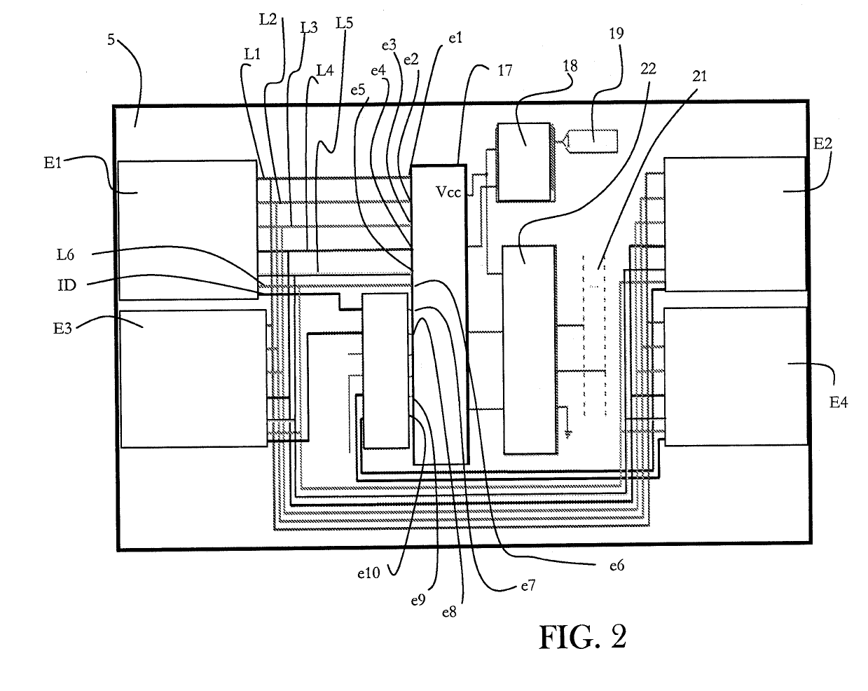

FIG. 2 is an overview connection diagram of a switching assembly of the control assembly of FIG. 1,

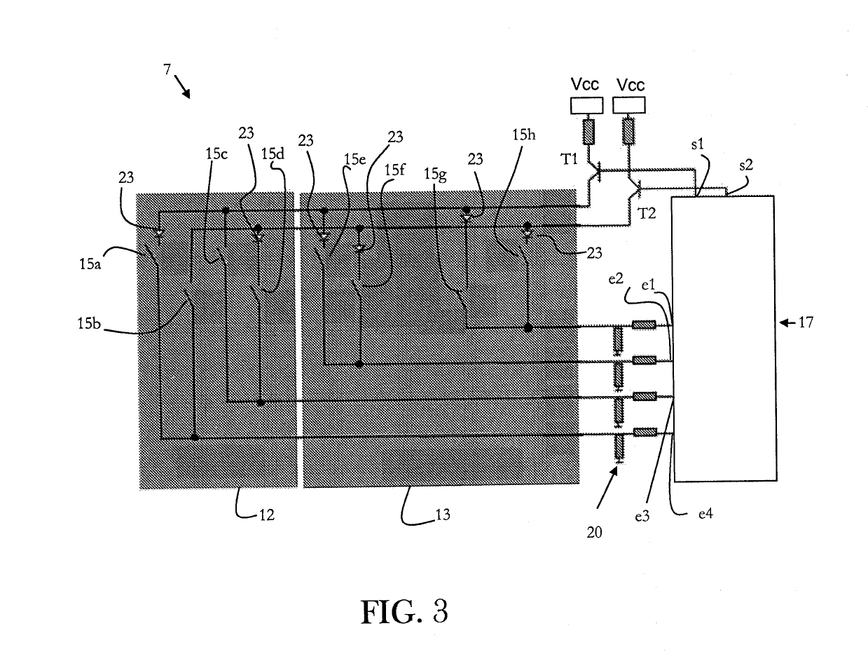

FIG. 3 is an overview connection diagram of a portion of the electric circuits of another example of a control assembly,

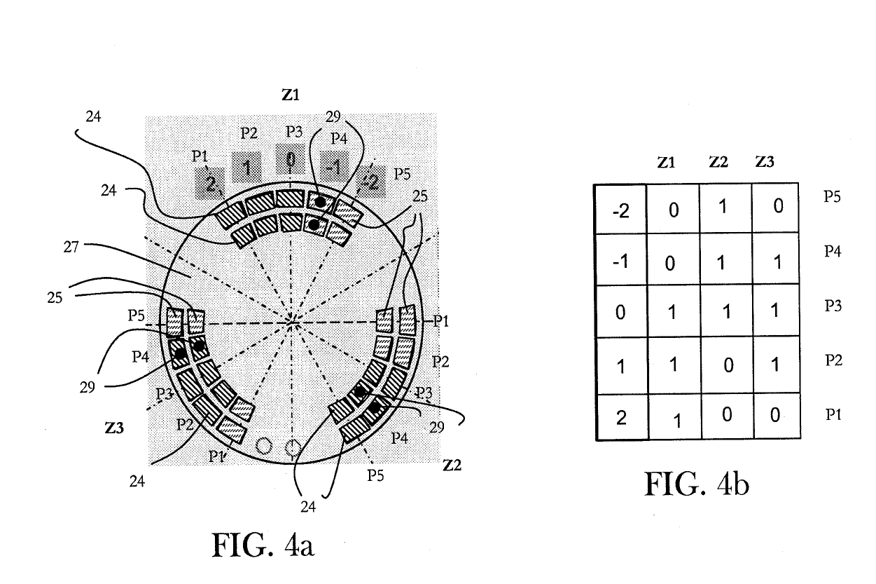

FIG. 4a is a schematic view of elements of an example of a switching module,

FIG. 4b is a table representative of the items of digital information coded by FIG. 4a,

FIG. 4c is an overview connection diagram of a portion of the electric circuits of a control assembly comprising the switching module of FIG. 4a, and

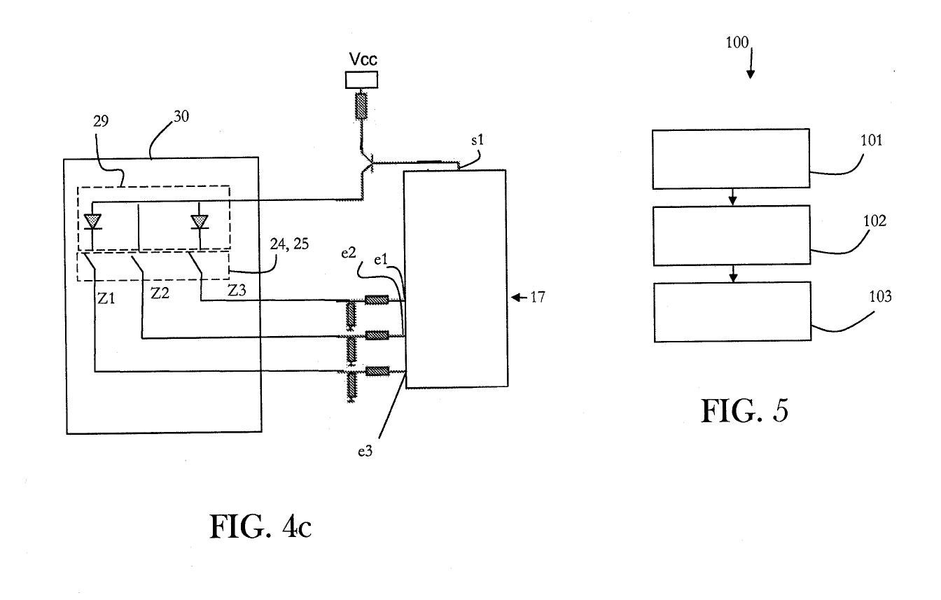

FIG. 5 represents a block diagram of a control method using a control assembly.

In these figures, the identical elements bear the same reference numbers. For the purposes of clarity, the steps of the control method are numbered from 100.

The invention relates to a control assembly for the top of a steering column of a motor vehicle comprising a switching assembly.

The control assembly is designed to be mounted on a steering column of a motor vehicle beneath a steering wheel (not shown).

At least one switching module may be plugged into a location of the switching assembly, each module having at least one switch that can adopt a switching state depending on a control position applied by a user.

For this, the switching assembly comprises a basic support having a plurality of locations that can be connected to switching module connectors and a microcontroller for managing the switching assembly. Each location also has the same predefined number of lands for connecting a predefined number of inputs e and of outputs s of the microcontroller to a switching module.

Moreover, the switching modules have on the one hand intrinsic and specific mechatronics which convert a movement of a user into a change of switching state and, on the other hand, a mechanical and electrical connection system to the support which is standardized in order to be identical for all the modules that can be connected to the basic support so that each switching module can be mechanically connected in each location of the support.

The switching modules are therefore mechanically connected in a location of the basic support and at the same time electrically connected.

FIG. 1 illustrates an example of the control assembly 1 comprising a switching assembly 3 of which the basic support 5 has four locations E1, E2, E3, E4 placed in pairs on opposite sides of the basic support 5, in order to accommodate switching modules 7 such as a lighting module or a switching module for the windshield wipers, a switching module for audio functions or a switching module for regulating speed, a switching module for a telephone or for a navigation system.

In this example, each location has the same predefined number of lands and the switching modules are standardized. Therefore, three types of different switching modules 8, 9, 10 are shown in ghosted lines superposed so as to illustrate their interchangeability at the various locations E1, E2, E3, E4 of the basic support 5.

Naturally, depending on the requirement, it is possible to envisage a higher number of switching modules 7 both with respect to their number for a single support 5 and for their functionalities.

Each location E1, E2, E3, E4 comprises at least two digital inputs connected to identical digital outputs s1, s2 of the microcontroller 17 and at least two digital outputs connected to identical digital inputs e1, e2, e3, e4 of the microcontroller 17.

More precisely and as can be seen in FIG. 2, each location E1, E2, E3, E4 comprises for example seven lands L1, L2, L3, L4, L5, L6, ID which can be connected on the one hand to associated connection tracks of the module 7 and, on the other hand, to the inputs e1, e2, e3, e4, e5, e6, e7 of the microcontroller 17.

Therefore, in this example, for the location E1, amongst the seven lands, six lands L1, L2, L3, L4, L5, L6 are connected to the inputs e1, e2, e3, e4, e5, e6 and are used to transmit switching states of the module 7 and one land ID is used for addressing and is connected to the input e7.

Each of the four locations E1, E2, E3 and E4 therefore comprises an ID land dedicated to addressing and connected to a dedicated input e7, e8, e9 and e10 of the microcontroller 17.

Naturally, it is possible to envisage, as required, a higher or lower number of lands both for the transmission of the switching state and for the transmission of the identifier to the microcontroller 17 if there is observance of the rule that the number N of lands is identical for all the locations E1 to E4 and for all the modules 7.

The lands L1, L2, L3, L4, L5, L6 of each location E1 to E4 are connected and coupled together on the same input e1, e2, e3, e4, e5, e6 of the microcontroller 17 so as to simplify the electric wiring. This reduces the number of inputs of the microcontroller 17 that are necessary for processing the information originating from each location E1, E2, E3, E4 of the switching assembly.

The microcontroller 17 is configured so as to be able to deduce from a sequence of digital signals sent by the microcontroller 17 to each location and digital signals received by the microcontroller 17 from each location E1, E2, E3, E4 and corresponding to electric signals having passed through a switching module plugged into a location, at least one switching state of a switch of the switching module.

Each sequence comprises a series of pulses sent to each output. The series of pulses comprises for example a succession of current pulses defining for example an item of binary information such as: “010101010 . . . ”. For each location, the sequences of digital signals are sent successively and cyclically to each output.

According to a first example, one current pulse is sent by turns in alternation to each output.

According to a second example, a first sequence comprising a succession of current pulses defining for example an item of binary information such as “010101010 . . . ” is sent to a first output for a predetermined period while nothing is sent to the second output. Then, a second sequence is sent to the second output for a predetermined period while nothing is sent to the first output.

The microcontroller 17 is also configured to receive an item of digital information comprising an identifier associated with the location E1, E2, E3, E4 of the module 7.

Moreover, it is also possible to envisage that the item of digital information deduced by the microcontroller 17 also contains an identifier of the location E1 to E4 and of the type of the module 7 connected to the switching assembly 3. The items of digital information are then different depending on the switching module through which the corresponding electric signals have passed so that the identification of the switching module is therefore directly deduced from the item of digital information without requiring a dedicated land.

According to a first embodiment shown in FIG. 3, the microcontroller 17 comprises four inputs e1, e2, e3, e4 and two outputs s1, s2 connected to switches of a module 7. In this example, the switches are interrupters which can adopt either an “open” switching state or a “closed” switching state.

In this first embodiment, the switching module 7 has two submodules 12, 13 each having four interrupters.

The switching module 7 is for example intended for the lighting.

The first submodule 12 is for example placed at the end of the switching module. It comprises a first rotating ring and a button for controlling the fog lamps. The modification by the user of the angular position of the first rotating ring and of the button make it possible to switch four interrupters 15a, 15b, 15c, 15d for controlling the fog lamps.

Two interrupters are connected on the one hand respectively to two outputs s1, s2 of the microcontroller 17 and, on the other hand, to a single input of the microcontroller 17.

Therefore, in the first submodule 12, the first two interrupters 15a, 15b are respectively connected on the one hand to two outputs s1 and s2 and, on the other hand to the input e4. The second two interrupters 15c, 15d are respectively connected on the one hand to two outputs s1 and s2 and, on the other hand, to the input e3.

The second submodule 13 is placed between the switching module and the first switching submodule. It comprises, for example, a second rotating ring for the control of the side lights and headlights. The modification by the user of the angular position of the second rotary ring makes it possible to switch four other interrupters 15e, 15f, 15g, 15h to control the side lights and headlights.

In the second submodule 13, the first two interrupters 15e, 15f are respectively connected on the one hand to the two outputs s1 and s2 and, on the other hand, to the input e2. The second two interrupters 15g, 15h are respectively connected on the one hand to the two outputs s1 and s2 and, on the other hand, to the input e1.

Therefore four inputs e1, e2, e3, e4 and two outputs s1, s2 are necessary for determining the switching states of the eight interrupters 15a to 15h instead of eight outputs and eight inputs on each interrupter. This considerably reduces the number of outputs of the microcontroller and the wiring necessary to determine the switching states of the switches.

Each output s1, s2 is connected to a powering means comprising for example a transistor T1, T2, plugged in, via the matching resistor Rp, to a supply voltage Vcc, via a regulator 18 connected to a battery 19 so that a digital output signal from the microcontroller 17 makes it possible to carry a current pulse to the switching module 7 for the reading of the switching states of the interrupters of a determined module.

Also provided is a low-pass filter 20 in front of each input e1, e2, e3, e4 of the microcontroller 17 in order to protect the inputs e1, e2, e3, e4 of the microcontroller 17.

In greater detail, if the microcontroller 17 applies a logical “1” signal to the base of one of the transistors T1 or T2, the latter is switched to the on state and the Vcc potential is applied to the switching module 7 thus making it possible to read the switching states.

Therefore, on receiving a signal from a digital output s1, s2 of the microcontroller 17, the switching module 7 receiving the signal is powered so as to allow the reading of the switching states of the interrupters and, in the absence of this signal, the associated connection tracks of the module 7 have a floating potential.

The microcontroller 17 is configured so as to deliver its output signals to a communication network, in particular a network bus 21 of the LIN or CAN type, via an interface 22 connected to the power supply Vcc.

Moreover, there are diodes 23 between the transistors T1 and T2 and the interrupters in order to prevent the current injected by the powering means to the interrupters returning to the latter and to prevent the interference of the interrupters connected to one and the same microcontroller input.

For example, on the electric circuits s1e1 and s2e1, between the two outputs s1 and s2 and the input e1 of the microcontroller 17, if the interrupters 15g and 15h are closed, the two diodes 23, respectively upstream of the interrupters 15g and 15h, prevent the injected current at the output s1 or s2 from returning to the transistors T1 or T2 in order to damage them.

The sequences are thus sent successively to one or the other of the two outputs s1, s2.

For example, and initially, a “1” output digital signal is sent to the first output s1 of the microcontroller 17 while a “0” output digital signal is sent to the second output s2.

The powering means comprising the transistor T1 then sends a current pulse to the interrupters 15a, 15c, 15e, 15g. The four inputs e1, e2, e3, e4 of the microcontroller 17 are then poled sequentially.

When the control position applied by a user closes all the interrupters, no voltage level is then received at the input e1, e2, e3, e4 of the microcontroller 17.

When the control position applied by the user opens all the interrupters, voltage levels are then received on all the inputs e1, e2, e3, e4 of the microcontroller 17 which transforms this item of information into an item of digital information.

If some of the interrupters are open according to the control position applied by the user, the voltage levels are then received on the corresponding inputs of the microcontroller 17 which transforms this item of information into an item of digital information. In the latter case, a multitude of items of information can be coded.

Then, secondly, a “0” output digital signal is sent to the first output s1 of the microcontroller 17 while a “1” output digital signal is sent to the second output s2.

The powering means comprising the transistor T2 then sends a current pulse to the interrupters 15b, 15d, 15f, 15h.

Then a “1” output digital signal is again sent to the first output s1 of the microcontroller 17 while a “0” output digital signal is sent to the second output s2. This defines sequences of digital signals, each sequence comprising a series of pulses sent successively and alternately to each output.

Therefore, the microcontroller 17 deduces from the sequence of digital signals, for example “01”, sent by the microcontroller 17 and from the digital signals received by the microcontroller after they have passed through the switching module 7, the eight switching states of the eight interrupters 15a to 15h.

These two steps are then carried out to each location for each switching module plugged in to said location of the switching assembly.

The microcontroller 17 then associates the items of digital information corresponding to the switching states, to a series of corresponding control signals.

It then delivers the corresponding control signals to the elements that have to be controlled.

The coding possibilities are then very high with limited wiring. The switching system is therefore simplified, more efficient and has a lower cost.

According to a second embodiment illustrated in FIGS. 4a, 4b and 4c, the switching module comprises a submodule 30 comprising a switch furnished with a corresponding switching member 29 in which only the contacting ends of the member are shown in FIG. 4a.

The switching member 29 comprises for example a rotating tripod capable of simultaneously switching three contacting elements of the switch in order to define a switching state of the switch.

The contacting elements comprise contacting lands 24 and grounds 25 inscribed in an arc of a circle band of a support of the module.

The contacting elements are duplicated except for a central position P3. The duplication of the contacting elements 24, 25 makes it possible to protect the routing of the electric signals in transit. If a contacting element or an electric line of the electric circuit comprising this contacting element were to be defective, the second contacting element (connected to a second electric circuit mounted in parallel) then makes it possible to remedy this defect.

The switching member 29 can rotate on the support 27 and can therefore adopt five positions P1, P2, P3, P4, P5 angularly offset on the support 27 in order to switch the contacting elements by frictional contact.

Each position P1, P2, P3, P4, P5 of the switching member 29 makes it possible therefore to define five switching states corresponding to the angular position of the tripod on the contacting elements.

The microcontroller 17 therefore comprises one output s1 and three inputs e1, e2, e3 connected to the submodule 30 of the switching module. The output s1 is, for example, connected to the switching member 29 and therefore to the three terminations of the tripod and the three inputs e1, e2, e3 are connected in parallel to the contacting elements of each zone Z1, Z2, Z3 (the switching member 29 and the contacting elements 24, 25 are schematized by three interrupters in FIG. 4c).

The position P1, P2, P3, P4, P5 of the switching member therefore defines a combination of contacts making it possible to establish a corresponding item of digital information at the input of the microcontroller 17 relative to a switching state of the switch after the signals have been sent to the switching module.

Therefore, in each zone Z1, Z2, Z3 of the support 27, represented in the example of FIGS. 4a and 4b, the position P1, P2, P3, P4, P5 of the switching member 29 can define five switching states: “010” or “−2”, “011” or “−1”, “111” or “0”, “101” or “1”, and “100” or “2”, by the positioning of the switching member 29 either on a contacting land 24 or on the ground 25.

Therefore, in the zone Z1 of FIG. 4A, the contacting elements 24 and 25 are placed so that the positions P1, P2, P3, P4, P5 of the switching member define successively a first, a second, a third closed contact and a fourth and a fifth open contact.

Similarly, in the zone Z2, the contacting elements 24 and 25 are placed so that the positions P1, P2, P3, P4, P5 of the switching member define successively a first and a second open contact and a third, a fourth and a fifth closed contact.

And, in the zone Z3, the contacting elements 24 and 25 are placed so that the positions P1, P2, P3, P4, P5 of the switching member define successively a first open contact, then a second, a third, a fourth closed contact and a fifth closed contact.

In the corresponding table of FIG. 4b, it is understood that each position P1, P2, P3, P4, P5 of the switching member 29 defines simultaneously a combination of several contacts relative to each of the three zones Z1, Z2, Z3, making it possible to define via a corresponding item of digital information to a switching state.

For example, a “1” output digital signal is sent to the first output of the microcontroller 17 while a “0” output digital signal is sent to the second output.

The powering means then sends a current pulse to the switching member 29. The three inputs e1, e2, e3 of the microcontroller 17 are then sequentially poled.

If the user moves the control member 29 to the position P4 (FIG. 4a), no voltage level is received on the input e3 of the microcontroller 17 corresponding to the zone Z1 and a voltage level is received on the two inputs e1 and e2 of the microcontroller 17 corresponding to the zones Z2 and Z3. The microcontroller 17 then converts this item of information into an item of digital information.

Therefore, the “−1” item of information, coded by the “011” item of digital information corresponds to a position P4 of the switching member 29 simultaneously defining an open contact in a first zone Z1, a closed contact in a second zone Z2 and a closed contact in a third zone Z3. This position is represented in FIG. 4a by the positioning of the ends of the switching member 29 on the contacting lands 24 of the zones Z2 and Z3 and on the grounds 25 of the zone Z1.

The truth table corresponding to the other possible positions of the switching member 29 is shown in the table of FIG. 4b and thus illustrates the five combinations “010”, “011”, “111”, “101” and “100” of the switching states corresponding to the five positions P1, P2, P3, P4, P5 of the switching member 29.

Therefore, said microcontroller 17 deduces from the sequence of digital signals, for example “01”, sent by the microcontroller 17 and from the digital signals received by said microcontroller after they have passed through the switching module, the switching state of the switch.

It is also possible for example to envisage several submodules in the switching module, mounted on several associated rotating elements.

A sequence of digital signals is then sent to a second output to another submodule of the switching module, then for each switching module plugged into a location of the switching assembly.

The microcontroller associates the items of digital information corresponding to the switching states with a series of corresponding control signals.

It then delivers the corresponding control signals to the elements that have to be controlled.

Moreover, the contacting lands 24 are placed so that the switching states are closed in a central position P3 of the switching member, corresponding to the “0” item of digital information in the example of FIG. 4a, or “111” on the corresponding line of the table of FIG. 4b, in order to carry out an operating test of the switching module.

In operation, the control method 100 can be used as shown by FIG. 5.

In a first step 101 of the method 100, a sequence of digital signals is sent by turns and periodically for each location E1, E2, E3, E4 to the outputs s1, s2 of the microcontroller 17.

Then, during a second step 102, corresponding electric signals that have passed through a switching module are received from each location E1, E2, E3, E4 at the input e1, e2 of said microcontroller 17.

Deduced from the sequences of digital signals sent and from the corresponding digital signals received is at least one switching state of a switch plugged into a location E1, E2, E3, E4.

During the second step 102, also deduced from sequences of digital signals sent and from corresponding digital signals received is at least one identifier associated with the location E1, E2, E3, E4 of the module 7.

During the second step 102, the switching state of a second preceding step 102 is stored, the switching state is compared with the stored switching state and if there is a change of the switching state, the second step 102 is reiterated until the switching state is identical at least to that stored.

The step of determining the switching state is therefore reiterated three times in succession when a change of switching state is determined in order to ensure that the user has indeed desired a change of state before the latter is made effective.

Then, in a third step 103, the switching states are associated with a series of corresponding control signals and the corresponding control signals are delivered to the elements that have to be controlled in order, for example, to control the intermittent wiping of the windshield wipers and finally the steps 101, 102, 103 are reiterated.

This gives a simplified and more efficient control assembly that can be easily standardized and in which it is easy to connect several optional modules to the switching assembly.

1. A switching assembly for the top of a steering column of a motor vehicle comprising:
a basic support having a plurality of locations that can be connected to switching module connectors, each switching module having at least one switch that can adopt a switching state depending on the control position applied by a user; and
a microcontroller for managing the switching assembly, wherein each location comprises at least two digital inputs connected to identical digital outputs of said microcontroller and at least two digital outputs connected to identical digital inputs of said microcontroller, and
wherein said microcontroller is configured to deduce from a sequence of digital signals sent by said microcontroller to each location and digital signals received by said microcontroller from each location and corresponding to electric signals having passed through a switching module plugged into a location, at least one switching state of a switch of said switching module.

2. The switching assembly as claimed in claim 1, wherein each location has the same predefined number of lands.

3. The switching assembly as claimed in claim 1, wherein the microcontroller is configured to receive an item of digital information also comprising an identifier (ID) associated with the location of said switching module.

4. A control assembly for the top of a steering column of a motor vehicle, comprising:
a switching assembly as claimed in claim 1; and
at least one switching module plugged into a location of the switching assembly, said module having at least one switch configured to adopt a switching state according to a control position applied by a user.

5. The control assembly as claimed in claim 4, wherein a predefined number of switches of a switching module are connected on the one hand respectively to an identical number of outputs of said microcontroller and, on the other hand, to a single input of said microcontroller.

6. The control assembly as claimed in claim 4, wherein the switch of the switching module comprises contacting elements and a corresponding switching member, the position of the switching member defining a combination of contacts making it possible to define an item of digital information corresponding to a switching state of the switch at the input of said microcontroller.

7. The control assembly as claimed in claim 6, wherein the contacting elements are inscribed in an arc of a circle band of a support of said module and said switching member is mounted rotatably on said support.

8. The control assembly as claimed in claim 6, wherein the contacting elements are duplicated for each position of the switching member with the exception of a central position.

9. The control assembly as claimed in claim 8, wherein the contacting elements are placed so that the switching states are closed in the central position of the switching member in order to carry out an operating test of said module.

10. A control method for the top of a steering column of a motor vehicle, comprising a control assembly as claimed in claim 4, the control method comprising the following steps:
sending, in turn and periodically for each location, a sequence of digital signals via said microcontroller;
receiving, from each location, corresponding digital signals via said microcontroller, the received signals being associated with electric signals that have passed through a switching module plugged into said location;
deducing from said sequences of digital signals sent and from said corresponding digital signals received, at least one switching state of a switch of said switching module,
associating the at least one switching state with a series of corresponding control signals;
delivering the corresponding control signals to elements that are to be controlled; and
reiterating said steps.

11. The control method as claimed in claim 10, further comprising:
deducing at least one identifier associated with the location of said module, from said sequences of digital signals sent and from said corresponding digital signals received, during the step of receiving corresponding digital signals.

12. The control method as claimed in claim 10, further comprising:
comparing the switching state during the step of receiving with a previously stored switching state, wherein when there is a change of switching state, the step of receiving is reiterated until the switching state is at least identical to that which is stored.
